(19) United States
(12) Patent Application Publication
(10) Pub. No.: US 2008/0293020 A1
(43) Pub. Date: Nov. 27, 2008

(54) Learner-Controlled Foreign Language Learning Processing Method and System

(76) Inventor: Sung-ok Jang, Gyeonggi-do (KR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/097,268

(22) PCT Filed: Mar. 22, 2007
(86) PCT No.: PCT/KR2007/001390

§ 371 Date: Jun. 13, 2008

(30) Foreign Application Priority Data
Mar. 23, 2006 (KR) 10-2006-0026646

(51) Int. Cl. G09B 19/06

(52) U.S. Cl. 434/157

(57) ABSTRACT

Learner-controlled foreign language learning method and system are disclosed. The method is performed by a learner's computer and an education server by providing foreign language learning contents to a computer through the Internet, and includes reproducing entire details of a selected foreign language learning content, determining whether there is a request for repeatedly reproducing, and reproducing the entire details of the foreign language learning content again when repeatedly reproducing is requested, processing a repeat-of-pronunciation by reading the details containing the foreign language learning content when the request for repeatedly reproducing is not asked; and processing the learning of the foreign language learning content by providing a question with respect to the details of the foreign language learning content and a request for an answer after the processing the repeat-of-pronunciation, and by comparing a learner's answer with the question.

### BACKGROUND OF THE INVENTION

1. Field of the Invention

The present invention relates to a foreign language learning method through the Internet and a system thereof, and more particularly, to a learner-controlled foreign language learning method of allowing a learner to control the learning of a foreign language and of giving the learner a motif of concentrating the learning of a foreign language and a system for performing the same.

2. Description of the Related Art

Unlike a conventional way for learning a foreign language regardless of the learner's ability, such as learning a foreign language using a CD in which foreign language learning contents are stored, or a textbook, at present, most of learners access an Internet site which provide various foreign language learning contents to learn a foreign language thanks to propagation of the Internet.

The foreign language learning system through the Internet will be described in brief as follows. The majority of the foreign language learning methods records an actual lectured situation with a video camera to transmit the recorded lecture through the Internet to the learner or provides the foreign language learning content selected by a click of a learner with a mouse, among the foreign language learning contents created by an education site, to the learner. However, in the foreign language learning method, since there is not a systemic process of learning foreign language but only the foreign language learning contents selected by the learner are provided, the learning effect of the learner is not high.

Moreover, since a young learner, who participates in the learning of the foreign language by parent's compulsion, generally has a relatively short time when the young learner concentrates the learning of the foreign language in comparison to an adult learner, the young learner easily loses an interest for the learning of the foreign language and stops the learning of the foreign language to play a game, to do web-surfing, or in expectation of the ending time of the class of learning the foreign language. Thus, it needs a foreign language learning method of stimulating the learner to have an interest of systemically learning the foreign language, learned under his/her control and a high strategic learning system for providing motif to the learner to concentrate the learning of the foreign language.

### SUMMARY OF THE INVENTION

Therefore, the present invention has been made in view of the above and/or other problems, and it is an aspect of the present invention to provide a leaner-controlled foreign language learning method in which the learning of a foreign language is progressed under the control of a learner, and a learner-controlled foreign language learning system.

It is another aspect of the present invention to provide a leaner-controlled foreign language learning method of making a learner concentrate the learning of a foreign language and a leaner-controlled foreign language learning system.

In accordance with the present invention, the above and other objects can be accomplished by the provision of a learner-controlled foreign language learning method carried out by a learner's computer and an education server to providing a plurality of foreign language learning contents to the learner computer through the Internet, comprising: reproducing entire details of a foreign language learning content selected from the plurality of foreign language learning contents by a learner; determining whether there is a request for repeatedly reproducing after the reproduction of the foreign language learning content, and reproducing the entire details of the foreign language learning content again when the request for repeatedly reproducing is asked; processing a repeat-of-pronunciation by reading the details containing the foreign language learning content when the request for repeatedly reproducing is not asked; and processing the learning of the foreign language learning content by providing a question with respect to the details of the foreign language learning content and a request for an answer after processing the repeat-of-pronunciation, and by comparing a learner's answer with the question.

Thus, according to the present invention, the learning-with-contents, the repeat-of-pronunciation, and the learning-by-questioning-and-answering are systemically processed by the native speaking teacher under the control of the learner, so that the learner directly attend the lecture for the foreign language and can learn the foreign language with interest in comparison to the conventional one-directional lecture.

Moreover, since the lecture time is shortened only when the learner concentrates on the lecture to repeat with a correct pronunciation and to correctly answer the provided questions, for example, a young learner who hopes the lecture finishes within a short time concentrates on the learning of the foreign language.

### BRIEF DESCRIPTION OF THE DRAWINGS

These and/or other objects and advantages of the present invention will become apparent and more readily appreciated from the following description of the embodiments, taken in conjunction with the accompanying drawings, in which:

FIG. 1 is a block diagram illustrating a learner-controlled foreign language learning system according to an embodiment of the present invention;

FIG. 2 is an exemplary view illustrating an expected answer memory in FIG. 1;

FIG. 3 is a flowchart schematically illustrating a learner-controlled foreign language learning method according to an embodiment of the present invention;

FIG. 4 is a flowchart illustrating a process of a repeat operation in FIG. 3; and

FIGS. 5 and 6 are flowcharts illustrating a process of a question and answer operation in FIG. 3.

### DESCRIPTION OF THE PREFERRED EMBODIMENTS

Hereinafter, embodiments of the present invention will be described in detail with reference to the accompanying drawings. In the following description of the present invention, if the detailed description of the already known structure and operation may confuse the subject matter of the present invention, the detailed description thereof will be omitted.

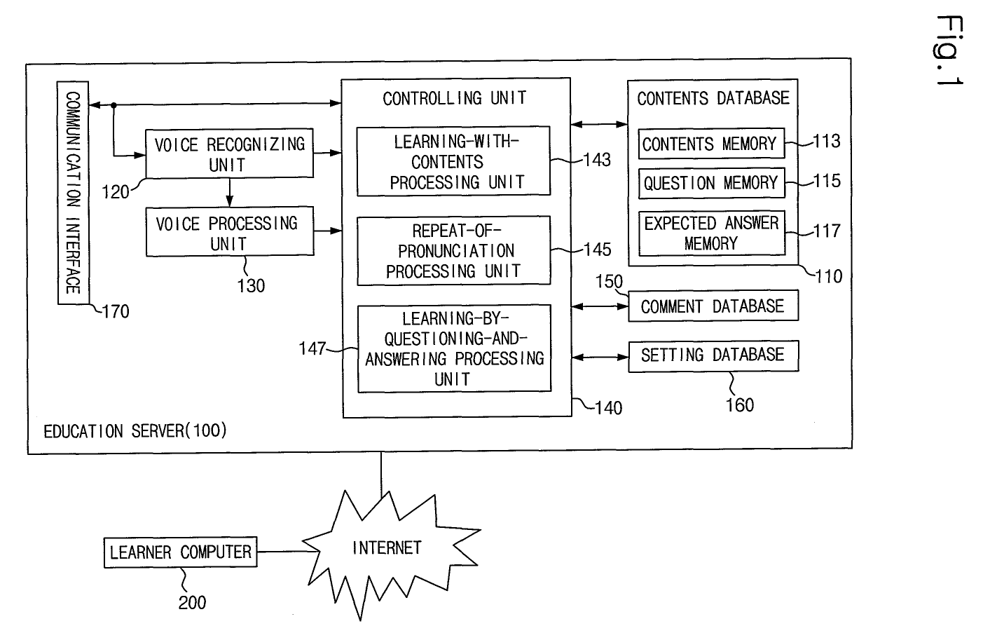

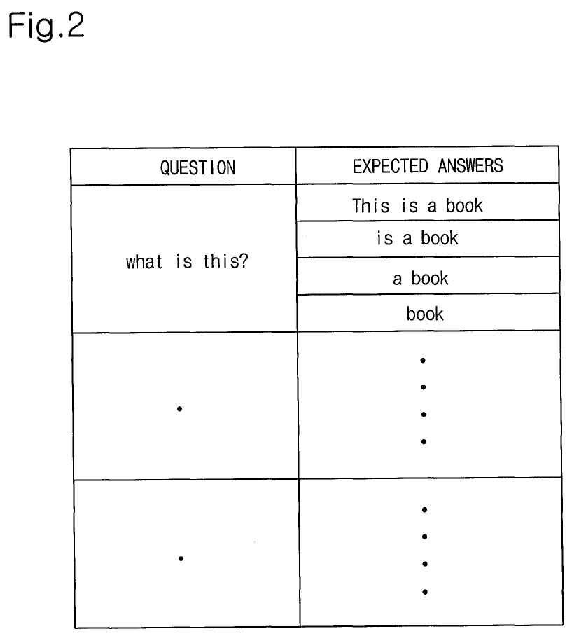

FIG. 1 is a block diagram illustrating a learner-controlled foreign language learning system according to an embodiment of the present invention, and FIG. 2 is an exemplary view illustrating an expected answer memory in FIG. 1.

Firstly, as illustrated in FIG. 1, an education server 100 of the learner-controlled foreign language learning system includes a contents database 110 to store a plurality of foreign language learning contents, questions corresponding to the respective foreign language learning contents, and a plurality of expected answers corresponding to the questions, a voice recognizing unit 120 to recognize voice of a learner, a voice processing unit 130 to convert the voice of the learner into texts, and a controlling unit 140 to determine learning stages of a learning-with-contents, a repeat-of-pronunciation, and a learning-by-questioning-and-answering.

In more detail, the contents database 110 stores various information about a learning-with-contents, a repeat-of-pronunciation, and a learning-by-questioning-and-answering, and includes an education contents memory 113, a question memory 115, and an expected answer memory 117.

The contents memory 113 may store various types of foreign language learning contents suitable for an age of a learner, such as English vocabularies, English music, a story-telling motion picture containing plural English voices, and the like. The question memory 115 stores at least one question relating to the detailed foreign learning contents of the foreign learning contents in order to determine whether the learner, who has selected and studied any one of the foreign language learning contents, precisely understood the selected foreign learning contents.

The expected answer memory 117 stores a required answer as a correct answer with respect to the question stored in the question memory 115 and a plurality of expected answers with respect to the question except for the required answer. In more detail, if the question memory 115 stores a question of “What is this?”, the expected answer memory 117, as illustrated in FIG. 2, does not store only the question of “What is this?”, and a correct answer (a required answer), “This is a book.” corresponding to the question, but also expectable text answers such as “Is a book.”, “A book.”, “Book.”, or the like in the form of a table.

The voice recognizing unit 120 receives a vocal answer of the learner and recognizes the repeated pronunciation of the learner and the vocal answer with respect to the question, transmitted from a computer 200 of the learner through the Internet to recognize the same. The voice processing unit 130 converts the learner's voice recognized by the voice recognizing unit 120 into text to transmit the converted text to the controlling unit 140, and can be implemented by a desired voice engine tool.

The controlling unit 140 controls the entire operation of the education server 100, determines educational stages of the learning-with-contents, the repeat-of-pronunciation, and the learning-by-questioning-and-answering according to the selection (answer) of the learner, and includes a learning-with-contents processing unit 143, a repeat-of-pronunciation processing unit 145, and a learning-by-questioning-and-answering processing unit 147.

The learning-with-contents processing unit 143 accesses entire details of the foreign language learning content from the plural foreign language learning contents that are stored in the contents memory 113 selected by the learner, and reproduces the selected foreign language learning content on a display of the computer 200 of the learner. When the entire details of the selected foreign language learning content is reproduced, the learning-with-contents processing unit 143 accesses a repeated reproduction question of asking whether or not to learn with the selected foreign language learning content again from a comment database 150 described later, and provides the accessed repeated reproduction question to the computer 200 of the learner. After that, the learning-with-contents processing unit 143 reproduces the entire details of the corresponding foreign language learning contents again when a repeated reproduction command is asked by the computer 200 of the learner, and outputs a reproduction learning command to the repeat-of-pronunciation processing unit 145 described later in order to perform a next learning stage when the repeated reproduction command is not asked.

When a repeated reproduction command is inputted from the learning-with-contents processing unit 143, the repeat-of-pronunciation processing unit 145 reads out the details of the foreign language learning contents and accesses a request for a repeat of pronunciation from the comment database 150, and provides the accessed request for a repeat of pronunciation to the computer 200 of the learner. The repeat-of-pronunciation processing unit 145 determines whether a repeated pronunciation of the learner with respect to the provided details of the foreign language learning content is correct, and determines the learning stage of the repeat-of-pronunciation according to the determination. For reference, if the foreign language learning content selected by the learner is the story-type motion picture, the details of the foreign language learning contents may be an English voice provided at every scene of the motion picture. In this case, the repeat-of-pronunciation processing unit 145 compares a text sentence corresponding to the provided English voice with the repeated pronunciation of the learner converted into text by the voice processing unit 130 and determines whether the learner correctly repeated the provided English voice.

In other words, when the repeated pronunciation of the learner with respect to the details of the provided foreign language learning content is correct, the repeat-of-pronunciation processing unit 145 provides a vocal file containing the repeated pronunciation of the learner and a reproduction command of reproducing the same to the computer 200 of the learner, and provides the request for a repeat of pronunciation. However, when the learner did not correctly repeat the pronunciation, the repeat-of-pronunciation processing unit 145 refers to set number information stored in a setting database 160, described later, to provide the details of the foreign language learning content and a request for a re-repeat of pronunciation to the computer 200 again, or provides only the details of the foreign language learning content to the computer 200 of the learner again and provides the next details of the foreign language learning content and the next request of a repeat of pronunciation.

After that, the repeat-of-pronunciation processing unit 145 provides the repeated reproduction question to the computer 200 of the learner. When the repeated reproduction command is asked, the repeat-of-pronunciation processing unit 145 repeatedly provides the repeat-of-pronunciation. When the repeated reproduction command is not asked, the repeat-of-pronunciation processing unit 145, in order to process the next learning stage, outputs a learning-by-questioning-and-answering processing command to a learning-by-questioning-and-answering processing unit 147 described later.

When the learning-by-questioning-and-answering processing command is inputted, the learning-by-questioning-and-answering processing unit 147 accesses a question corresponding to the details of the provided foreign language learning content from the question memory 115, a request for an answer from the comment database 150 to provide the accessed question and request for an answer to the computer 200 of the learner. After this, the learning-by-questioning-and-answering processing unit 147 accesses a plurality of expected answers containing the required answer corresponding to the provided question from the expected answer memory 117, and compares the accessed the expected answers with the answer of the learner converted into the text by the voice processing unit 130. The learning-by-questioning-and-answering processing unit 147 determines the learning stage of the learning-by-questioning-and-answering according to the comparison. In more detail, when the answer of the learner is a correct answer (required answer) with respect to the provided question, the learning-by-questioning-and-answering processing unit 147 provides the vocal file containing the repeated pronunciation of the learner and the reproduction command of reproducing the same to the computer 200 of the learner, and provides a next question.

However, when the learner's answer is not the required answer, the learning-by-questioning-and-answering processing unit 147 determines the learning stage of the learning-by-questioning-and-answering by comparing the number of times when the learner's answer is wrong with the expected answers. In other words, when the number of times when the learner's answer for the provided question is wrong is 1 (one) and the learner's answer corresponds to one of the expected answers, the learning-by-questioning-and-answering processing unit 147 requests the learner to answer again in a full sentence and provides the corresponding question again. Moreover, when the number of times when the learner's answer for the provided question is wrong is 2 (two) and the learner's answer corresponds to one of the expected answers, the learning-by-questioning-and-answering processing unit 147 provides an encouraging comment, the required answer, and the request for a repeat of pronunciation. After this, the learning-by-questioning-and-answering processing unit 147 provides the repeated reproduction question to the computer 200 of the learner. The learning-by-questioning-and-answering unit 147 repeatedly provides the learning-by-questioning-and-answering when the repeated reproduction command is requested, and completes entire learning process when the repeated reproduction command is not requested.

Therefore, according to the feature of the present invention, since the learning-with-contents, the repeat-of-pronunciation, and the learning-by-questioning-and-answering are systemically processed by a cyber native speaker teacher under the control of the learner, the learner can learn the foreign language with interest in comparison to the conventional one-directional lecture. Moreover, since time for the repeat-of-pronunciation and the learning-by-questioning-and-answering is increased and decreased according to whether the learner concentrates his/her effort to learn the foreign language, for example, a young learner can devote the learning of the foreign language for the purpose of finishing the learning of a foreign language as soon as possible.

Meanwhile, the education server 100 further includes the comment database 150 and the setting database 160, and a communication interface 170.

The comment database 160 stores a repeated reproduction question such as ‘Do you want to practice again?’, a request for a repeat of pronunciation such as ‘Listen and repeat’, a request for a repeat of pronunciation again such as ‘Please listen and repeat’, a request to answer in a full sentence such as ‘Good, make a full sentence’, a request for an answer such as ‘Listen and answer’, and various comments required in processing the learning of the foreign language such as an encouraging comment of ‘Good’.

The setting database 160 stores the set number information about how many times will be further provided to the learner when the repeated pronunciation of the learner is incorrect or the answer of the learner for the question is wrong in the repeat-of-pronunciation and the learning-by-questioning-and-answering. On the other hand, the communication interface 170 transmits various foreign language learning contents provided based on the command from the controlling unit 140 to the computer 200 of the learner through the Internet, and receives the repeated pronunciation and the vocal answer of the learner from the computer 200 of the learner to transmit the same to the voice recognizing unit 120 and the controlling unit 140.

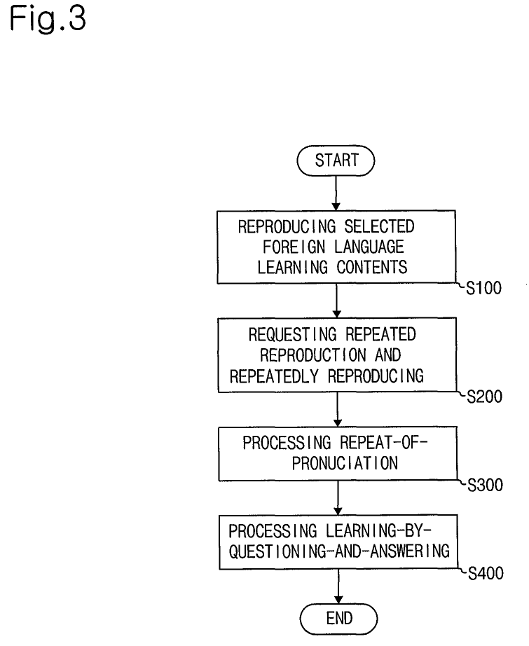

Hereinafter, the learner-controlled foreign language learning method according to the embodiment of the present invention will be described in detail. Firstly, FIG. 3 is a flowchart schematically illustrating a learner-controlled foreign language learning method according to an embodiment of the present invention.

As illustrated, the learner-controlled foreign language learning method includes reproducing (S100) and repeatedly reproducing (S200) the foreign language learning contents selected by the learner, processing the repeat-of-pronunciation (S300), and processing the learning-by-questioning-and-answering (S400).

The learning-by-questioning-and-answering processing unit 143 accesses entire details of the foreign language learning content selected by the learner from the plurality of the foreign language learning contents stored in the contents memory 113 and reproduces the accessed entire details of the foreign language learning content on a display of the computer 200 of the learner (S100). After this, when the entire details of the foreign language learning content are reproduced, the learning-with-contents processing unit 143 accesses the repeated reproduction question to ask whether or not to study the foreign language learning content again, that is, ‘Do you want to practice again?’ from the comment database 150, and provides the accessed repeated reproduction question to the computer 200 of the learner.

When the repeated reproduction command of ‘Yes’ with respect to the repeated reproduction question is requested by the learner from the voice recognizing unit 120, the learning-with-contents processing unit 143 reproduces the entire detail of the selected foreign language learning content again (S200). However, when the repeated reproduction command is not requested (when the learner answers ‘No’), the learning-with-contents processing unit 143 outputs a repeat-of-pronunciation processing command to the repeat-of-pronunciation processing unit 145 in order to process the repeat-of-pronunciation of the corresponding foreign language learning content.

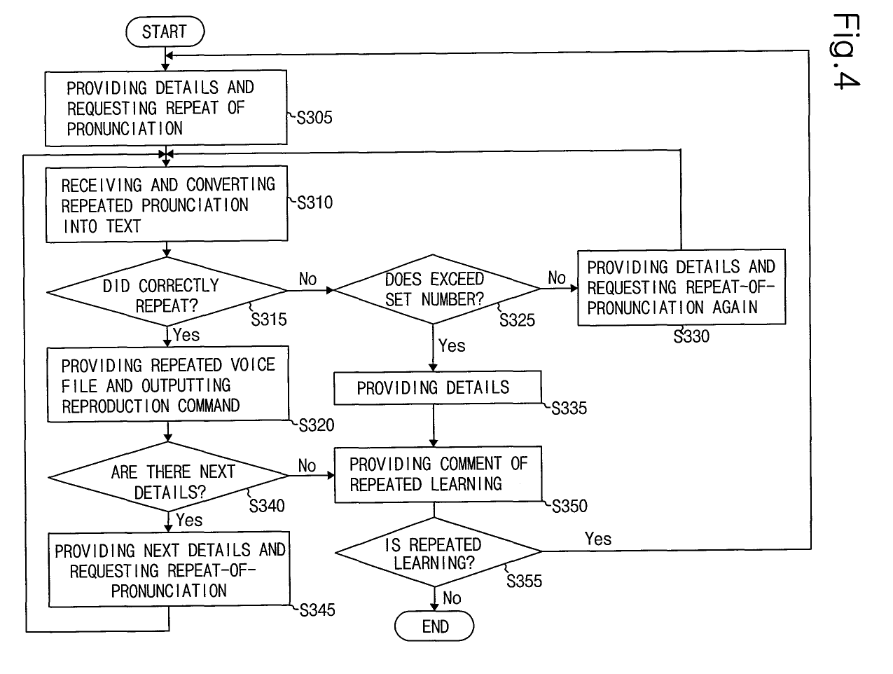

Hereinafter, the process of the repeat-of-pronunciation will be described in detail with reference to FIG. 4. FIG. 4 is a flowchart illustrating a process of a repeat operation in FIG. 3.

As illustrated, when the repeat-of-pronunciation processing command is inputted from the learning-with-contents processing unit 143, the repeat-of-pronunciation processing unit 145 reads out the details of the foreign language learning content provided to the learner, and accesses the request for a repeat of pronunciation such as ‘Listen and repeat’ from the comment database 150 to provide the read details of the foreign language learning content and the accessed request for a repeat of pronunciation to the computer 200 of the learner (S305).

When the repeated pronunciation of the learner, who has listened to the details of the foreign language learning content is inputted through the communication interface 170, the voice processing unit 130 converts the inputted repeated pronunciation into a text form to transmit the converted text to the repeat-of-pronunciation processing unit 145 (S310). The repeat-of-pronunciation processing unit 145 received the repeated pronunciation of the learner converted into text, as described above, compares the text sentence and vocabularies, corresponding to the details of the foreign language learning content provided to the computer 200 of the learner, with the repeated pronunciation of the learner converted into the text by the voice processing unit 130 to determine whether or not the learner correctly repeated (S315).

When the repeated pronunciation of the learner accords with the details of the provided foreign language learning content, the repeat-of-pronunciation processing unit 145 transmits the vocal file repeated by the learner and a reproduction command of the vocal file to the computer 200 of the learner (S320). However, when the repeated pronunciation of the learner does not accord with the details of the provided foreign language learning content, the repeat-of-pronunciation processing unit 145 refers to the set number information stored in the setting database 160 and determines whether an opportunity of repeating again could be provided to the learner (S325).

In other words, when the set number of times (opportunity of repeating again) is twice and the number of times when the repeated pronunciation of the learner is not correct is once, the repeat-of-pronunciation processing unit 145 determines the learner's opportunity does not excess the set number of times (the opportunity of repeating again still remains), and accesses and provides the request of a repeat of pronunciation again of ‘Please listen and repeat’ to the learner as well as the details of the foreign language learning content again to the learner (S330). However, when the learner's opportunity exceeds the set number of times (there is no opportunity of the learner), the repeat-of-pronunciation processing unit 145 provides only the details of the provided foreign language learning content without request for a repeat of pronunciation again (S335).

After that, the repeat-of-pronunciation processing unit 145 determines whether there is another detail of the corresponding foreign language learning content (S340). As a result of the determination, when a next detail of the corresponding foreign language learning content remains, the repeat-of-pronunciation processing unit 145 reads out the next details from the foreign language learning content and the read next details together the request for a repeat of pronunciation to the computer 200 of the learner (S345). However, there is not the next detail of the foreign language learning content, the repeat-of-pronunciation processing unit 145 accesses and provides a repeated learning question of ‘Do you want to practice again?’ from the comment database 150 to the computer 200 of the learner (S350).

When the repeated reproduction question of ‘Yes’ is asked by the recognizing unit 120, the repeat-of-pronunciation processing unit 145 repeatedly processes the above-mentioned repeat-of-pronunciation. When the repeated reproduction question is not asked (the learner answers ‘no’), the repeat-of-pronunciation processing unit 145 outputs a command of processing the learning-by-questioning-and-answering to the learning-by-questioning-and-answering processing unit so as to determine whether or not the learner fully understood the details of the corresponding foreign language learning content (S355).

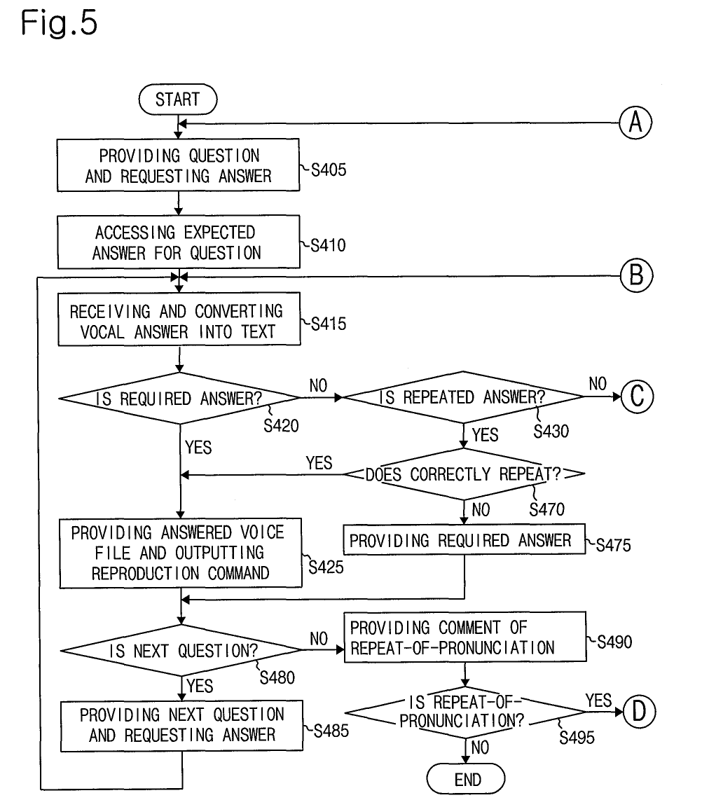

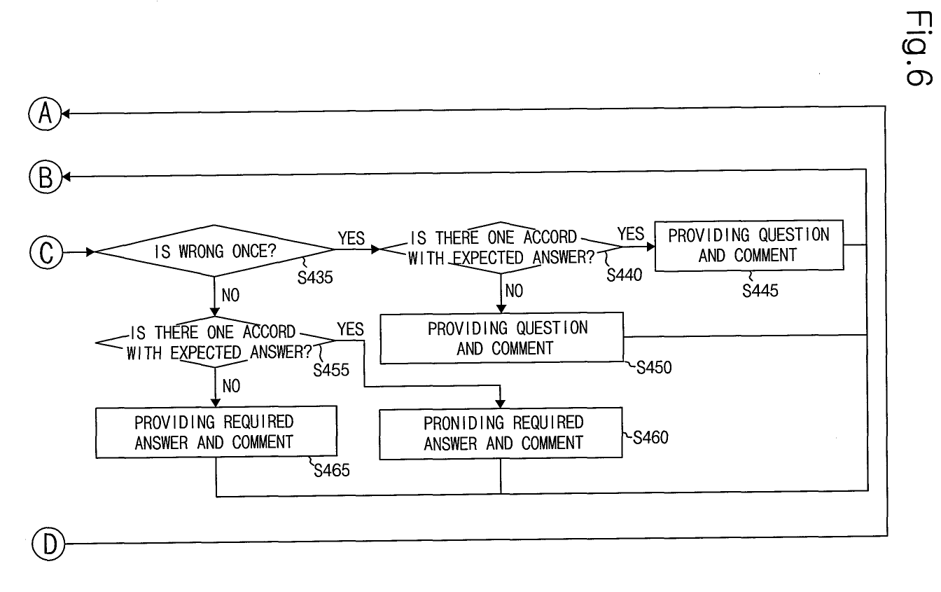

Hereinafter, with reference to FIGS. 5 and 6, the process of the learning-by-questioning-and-answering will be described in detail. FIGS. 5 and 6 are flowcharts illustrating a process of a question and answer operation in FIG. 3.

As illustrated in the drawings, when the learning-by-questioning-and-answering processing command is inputted from the repeat-of-pronunciation processing unit 145, the learning-by-questioning-and-answering processing unit 147 a question corresponding to the details of the foreign language content provided to the learner from the question memory 113 and the request for an answer of ‘Listen and answer’ from the comment database 150 to provide the accessed question and request to the computer 200 of the learner (S405). Moreover, the learning-by-questioning-and-answering processing unit 147 accesses a plurality of expected answers containing a required answer corresponding to the provided question from the expected answer memory 117 (S410).

When a voice answered by the learner who has listened to the corresponding question is inputted from the communication interface 170, the voice processing unit 130 converts the vocal answer of the learner into text and transmits the converted text to the learning-by-questioning-and-answering processing unit 147 (S415). After that, the learning-by-questioning-and-answering processing unit 147 compares the learner's answer converted into the text by the voice processing unit 130 with the accessed required answer and the expected answers to determine the learning stage based on the comparison.

For example, the learning-by-questioning-and-answering processing unit 147 provides a question of ‘What is this?’ If the accessed required answer corresponding to provided question were ‘This is a book’, the learning-by-questioning-and-answering processing unit 147 determines whether the learner's answer converted into the text by the voice processing unit 130 accords with the required answer (S420). If the learner's answer accords with the required answer, the learning-by-questioning-and-answering processing unit 147 transmits the voice file of the learner's answer and a reproduction command of reproducing the voice file to the computer 200 of the learner (S425).

However, when the learner's answer does not accord with the required answer, the learning-by-questioning-and-answering processing unit 147 determines whether or not the learner's answer converted into the text is the repeated pronunciation (S430). According to the learner-controlled foreign language learning method of the present invention, the learning-by-questioning-and-answering provides a total of three opportunities of answering with respect to the provided question. In other words, the learning-by-questioning-and-answering is processed such that, when the learner's answer for the provided question is not a full sentence (required answer), similarity of the answers and the number of times when the answers are wrong are determined, and a question and/or a required answer which correspond to the determination are provided to the computer 200 of the learner.

In more detail, the learning-by-questioning-and-answering is processed such that the corresponding question is provided again when the number of times when the learner's answer with respect to the corresponding question is not the required answer is once, the corresponding question and the required answer are provided and request to repeat the required answer when the number of times is twice, and finally whether or not the repeated pronunciation of the learner with respect to the provided required answer is correct is determined.

Therefore, when the learner's answer does not accord with the required answer in the operation S420, the learning-by-questioning-and-answering processing unit 147 must determine whether the present learner's answer is not an answer with respect to the provided question but the repeated pronunciation (S430). When the present learner's answer is not the repeated pronunciation, the learning-by-questioning-and-answering processing unit 147 determines whether the number of times when the learner's answer with respect to the corresponding question is not the required answer is once (S435).

When the number of times when the learner's answer is not the required answer is once as a result of the determination, in order to determine whether the learner's answer is not the required answer (correct answer) but is similar as the required answer, the learning-by-questioning-and-answering processing unit 147 determines whether the learner's answer accords with any one of the plurality of expected answers (for example, ‘Is a book’, ‘A book’, ‘Book’, or the like) except for the required answer (S440).

When the learner's answer accords with any one of the plurality of expected answers, the learning-by-questioning-and-answering processing unit 147 provides the corresponding question and accesses a request of answering in a full sentence of ‘Good, make a full sentence’ again from the comment database 150 to provided the accessed request to the computer 200 of the learner (S445). However, when the learner's answer accords with none of the plurality of expected answers, the learning-by-questioning-and-answering processing unit 147 provides the corresponding question and accesses a comment of answering again such as ‘Try again’ from the comment database 150 to provide the accessed comment to the computer 200 of the learner (S450).

On the other hand, when the number of times when the learner's answer is not the required answer is more than once in the operation S435, the learning-by-questioning-and-answering processing unit 147 determines whether or not the learner's answer accords with any one of the plurality of accessed expected answers (S455). If the learner's answer accord with any one of the plurality of the accessed expected answers, the learning-by-questioning-and-answering processing unit 147 accesses an encouraging comment of ‘Good’ and the request for a repeat of pronunciation from the comment database 150 and provides the accessed comment and request together with the corresponding question and the required answer to the computer 200 of the learner (S460). However, when the learner's answer does not accord with any one of the plurality of the expected answers, the learning-by-questioning-and-answering processing unit 147 accesses the request for a repeat of pronunciation from the comment database 150 and provides the accessed request together with the corresponding question and the required answer to the computer 200 of the learner (S465).

On the other hand, when the present learner's answer converted into the text is the repeated pronunciation in the operation S430, the learning-by-questioning-and-answering processing unit 147 determines whether or not the learner correctly repeated the provided required answer (S470). When the learner correctly repeated the provided required answer, the learning-by-questioning-and-answering processing unit 147 provides the voice file of the learner's answer and a reproduction command of reproducing the same to the computer 200 of the learner. However, when the learner does not correctly repeat the provided required answer, the learning-by-questioning-and-answering processing unit 147 does not provide additional opportunity of answering the provided required answer but only the required answer with respect to the provided question to the computer 200 of the learner (S475).

After that, the learning-by-questioning-and-answering processing unit 147 determines whether there is a next question corresponding to the details of the corresponding foreign language learning content in the question memory 115 (S480). If there is a next question, the learning-by-questioning-and-answering processing unit 147 provides the next question and the request for an answer to the computer 200 of the learner and repeats the above-described operations. However, when there is not a next question, the learning-by-questioning-and-answering processing unit 147 accesses the repeated learning question of ‘Do you want to practice again?’ from the comment database 150 to provide the same to the computer 200 of the learner. (S490).

The learning-by-questioning-and-answering processing unit 147 repeats the above-described learning-by-questioning-and-answering when the repeated reproduction command of ‘Yes’ is asked by the voice recognizing unit 120, and finishes every learning when the repeated reproduction command is not asked. (S495).

Thus, according to the present invention, the learning-with-contents, the repeat-of-pronunciation, and the learning-by-questioning-and-answering are systemically processed by the native speaker teacher under the control of the learner, so that the learner can directly attend the lecture for the foreign language and can learn the foreign language with interest in comparison to the conventional one-directional lecture.

Moreover, since the lecture time is shortened only when the learner concentrates on the lecture to repeat with a correct pronunciation and to correctly answer to the provided question, for example, a young learner who hopes the lecture finishes within a short time concentrates on the learning of the foreign language.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A learner-controlled foreign language learning method carried out by a learner's computer and an education server to providing a plurality of foreign language learning contents to the learner computer through the Internet, comprising:
reproducing entire details of a foreign language learning content selected from the plurality of foreign language learning contents by a learner;
determining whether there is a request for repeatedly reproducing after the reproduction of the foreign language learning content, and reproducing the entire details of the foreign language learning content again when the request for repeatedly reproducing is asked;
processing a repeat-of-pronunciation by reading the details containing the foreign language learning content when the request for repeatedly reproducing is not asked; and
processing the learning of the foreign language learning content by providing a question with respect to the details of the foreign language learning content and a request for an answer after processing the repeat-of-pronunciation, and by comparing a learner's answer with the question.

2. The learner-controlled foreign language learning method according to claim 1, wherein the processing the repeat-of-pronunciation comprises:
providing a request for a repeat of pronunciation together with the details contained in the foreign language learning content selected, among the plurality of the foreign language learning contents that contain at least one of motion pictures containing a plurality of English voices, by the learner to the learner computer;
receiving a repeated pronunciation of the learner and converting the received repeated pronunciation into text by a predetermined voice tool to compare the provided details of the foreign language learning content with the repeated pronunciation of the learner converted into the text;
providing a voice file of the learner to the learner computer and outputting a reproduction command when the learner correctly repeated as a result of the comparison, and providing the details of the foreign language learning content for a set number of times again when the learner does not correctly repeat and requesting for a re-repeat of pronunciation; and
providing the details of the foreign language learning content and next details of the foreign language learning content when the set number of times is exceeded.

3. The learner-controlled foreign language learning method according to claim 1, wherein the processing of the learning-by-questioning-and-answering comprises:
providing the question with respect to the details of the foreign language learning content and the request for an answer after processing the repeat-of-pronunciation and accessing a plurality of expected answers containing a required answer with respect to the provided question;
receiving a vocal answer of the learner with respect to the question and converting the received vocal answer into text by a predetermined voice tool to compare the vocal answer of the learner converted into the text with the required answer;
providing a voice file of the vocal answer of the learner to the learner computer and outputting a reproduction command when the vocal answer of the learner accords with the required answer as a result of the comparison in the receiving of a vocal answer; and
determining whether there is the learner's answer that accords with any one of the plurality of expected answers except for the required answer when the learner's answer does not accord with the required answer, and providing the question and/or the required answer to the learner computer according to the result of the determination.

4. The learner-controlled foreign language learning method according to claim 3, wherein the determining comprises:
determining whether the learner's answer accords with any one of the plurality of expected answers when the number of times where the learner's answer does not accord with the required answer is one, and providing different comments together with the question again according to the determination;
determining whether the learner's answer accords with any one of the plurality of expected answers when the number of times where the learner's answer does not accord with the required answer is twice, and providing different comments together with the question and a request for a repeat of the required answer according to the determination; and
providing a voice file of a repeated pronunciation of the learner to the learner computer when the repeated pronunciation of the learner received from the learner computer according to a request for a repeat of pronunciation and outputting the reproduction command, and providing the required answer again and a next question when the repeated pronunciation of the learner does not accord with the required answer.

5. A learner-controlled foreign language learning system comprising:
a learner computer; and
an education server to provide a plurality of foreign language learning contents to the learner computer through the Internet, the education server comprising:
a contents database including a contents memory to store the plurality of foreign language learning contents, a question memory to store a question relating to the details of the respective foreign learning contents, and an expected answer memory to store a plurality of expected answers with respect to the question containing a required answer corresponding to the question;
a voice recognizing unit to recognize a voice of the learner inputted by the learner computer through the Internet;
a voice processing unit to convert the voice of the learner recognized by the voice recognizing unit into text; and
a controlling unit comprising:
a learning-with-contents processing unit to access the foreign language learning content selected by the learner from the contents memory to reproduce entire details of the foreign language learning content and to reproduce the foreign language learning content again when there is a repeated reproduction command;
a repeat-of-pronunciation processing unit to read the details contained in the foreign language learning contents to provide the details together with a request for a repeat of pronunciation to the learner computer, to determine whether or not a repeated pronunciation transmitted from the learner is correct to determine a learning stage, and to provide the details and the request for a repeat of pronunciation according to a choice of the learner again; and
a learning-by-questioning-and-answering processing unit to provide the question with respect to the details and a request for an answer to the learner's computer, to compare the question with a learner's answer to determine the learning stage according to the comparison, and to provide the question and the request for an answer according to the choice of the learner.
